(19) United States
(12) Patent Application Publication
(10) Pub. No.: US 2025/0168841 A1
(43) Pub. Date: May 22, 2025

(54) INFORMATION PROCESSING METHOD

(71) Applicant: TOYOTA JIDOSHA KABUSHIKI KAISHA, Toyota-shi (JP)

(72) Inventors: Hayato MIZUMA, Tokyo (JP); Kohei MIWA, Nagaizumi-cho (JP)

(73) Assignee: TOYOTA JIDOSHA KABUSHIKI KAISHA, Toyota-shi (JP)

(21) Appl. No.: 18/785,275

(22) Filed: Jul. 26, 2024

(30) Foreign Application Priority Data
Nov. 20, 2023 (JP) 2023-196833

(51) Int. Cl. H04W 72/121; H04L 67/12; H04W 4/40; H04W 64/00

(52) U.S. Cl. CPC H04W 72/121; H04L 67/12; H04W 4/40; H04W 64/006

(57) ABSTRACT

An information processing method in V2X communication executed by an information processing device of a moving object includes: setting a group ID related to a group including at least one other moving object satisfying a predetermined condition; and in the V2X communication, adding the group ID to perform data communication.

### CROSS-REFERENCE TO RELATED APPLICATION

This application claims priority to Japanese Patent Application No. 2023-196833 filed on Nov. 20, 2023, incorporated herein by reference in its entirety.

### BACKGROUND

### 1. Technical Field

The present disclosure relates to information processing methods.

### 2. Description of Related Art

Conventionally, techniques have been known in which alerts, danger warnings, etc. are given by vehicle-to-everything (V2X) communication such as vehicle-to-vehicle communication and vehicle-to-pedestrian communication. For example, Japanese Unexamined Patent Application Publication No. 2016-224946 (JP 2016-224946 A) discloses a pedestrian terminal device that allows power saving of the pedestrian terminal device in vehicle-to-pedestrian communication.

### SUMMARY

In the technique disclosed in JP 2016-224946 A, when a plurality of vehicle-to-pedestrian communication terminals carried by pedestrians is located close to each other, a pedestrian terminal group is formed, and a pedestrian terminal representing the group is determined. This representative terminal communicates with a vehicle on behalf of the group. In particular, the technique of JP 2016-224946 A attempts to save power and avoid communication interruption by determining a representative terminal that performs communication based on the remaining battery capacities of the terminals etc. In the technique of JP 2016-224946 A, however, since the vehicle communicates with the terminals in the group via the representative terminal, communication between the non-representative terminals in the group and the vehicle is slower than in the case where the vehicle directly communicates with the terminals in the group. On the other hand, giving alerts, danger warnings, etc. by one-to-one communication or broadcast communication would require sufficiently communication resources and calculation resources, and these resources may run short. As described above, there is room for improvement in vehicle-to-everything (V2X) communication technology.

An object of the present disclosure made in view of such circumstances is to improve the V2X communication technology.

An information processing method according to one embodiment of the present disclosure is an information processing method in vehicle-to-everything communication that is performed by an information processing device of a moving object. The information processing method includes:
setting a group identification for a group including at least one other moving object that satisfies a predetermined condition; and
adding the group identification to perform data communication in the vehicle-to-everything communication.

The embodiment of the present disclosure improves the vehicle-to-everything communication technology.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration example of a system according to an embodiment of the present disclosure;

FIG. 2 is a block diagram illustrating a schematic configuration example of an information processing device;

FIG. 3 is a flowchart illustrating an operation example of the information processing device;

FIG. 4 is a flow chart illustrating an exemplary method of setting a group ID;

FIG. 5 shows an embodiment of grouping; and

FIG. 6 shows a conceptual diagram of communication when a group ID is set.

### DETAILED DESCRIPTION OF EMBODIMENTS

Hereinafter, a technique according to an embodiment of the present disclosure will be described with reference to the drawings.

In each drawing, the same or corresponding portions are denoted by the same reference signs. In the description of the present embodiment, description of the same or corresponding components will be appropriately omitted or simplified.

First, an outline of the present embodiment will be described. A technique according to an embodiment of the present disclosure is an information processing method in V2X communication that is performed by an information processing device of a moving object. The information processing device sets a group ID related to a group including at least one other moving object satisfying a predetermined condition. Further, the information processing device adds the group ID to the data in V2X communication. That is, the information processing device adds the group ID to the data in V2X communication to perform data communication.

As described above, according to the present embodiment, the information processing device included in the moving object sets a common group ID in the group including at least one other moving object satisfying the predetermined condition, adds the group ID to the data in V2X communication, and performs data communication. By adding the group ID to the data of V2X communication, the devices that perform the data communication can utilize the group ID. For example, the destination of the data-transmission can be specified by a group ID. In addition, it is easy to determine whether or not the data is the data whose destination is self by the group ID. In this way, V2X communication technique is improved in that a group including a plurality of moving objects can utilize a common group ID in V2X communication.

Here, the moving object is, for example, a vehicle, a pedestrian, or the like. For example, when the moving object is a vehicle, the information processing device 20 may be a dedicated device or the like mounted on the moving object. When the moving object is a pedestrian, the information processing device may be a portable terminal such as a smartphone carried by the pedestrian. When the information processing device is mounted on the vehicle, the vehicle and the information processing device may be wired by Controller Area Network (CAN) or the like. In addition, the standard of the wired connection when the wired connection is performed is not limited to CAN. The vehicle is, for example, an automobile, but is not limited thereto, and may be any vehicle, and may be a motorcycle, a bicycle, or the like.

### System Configuration

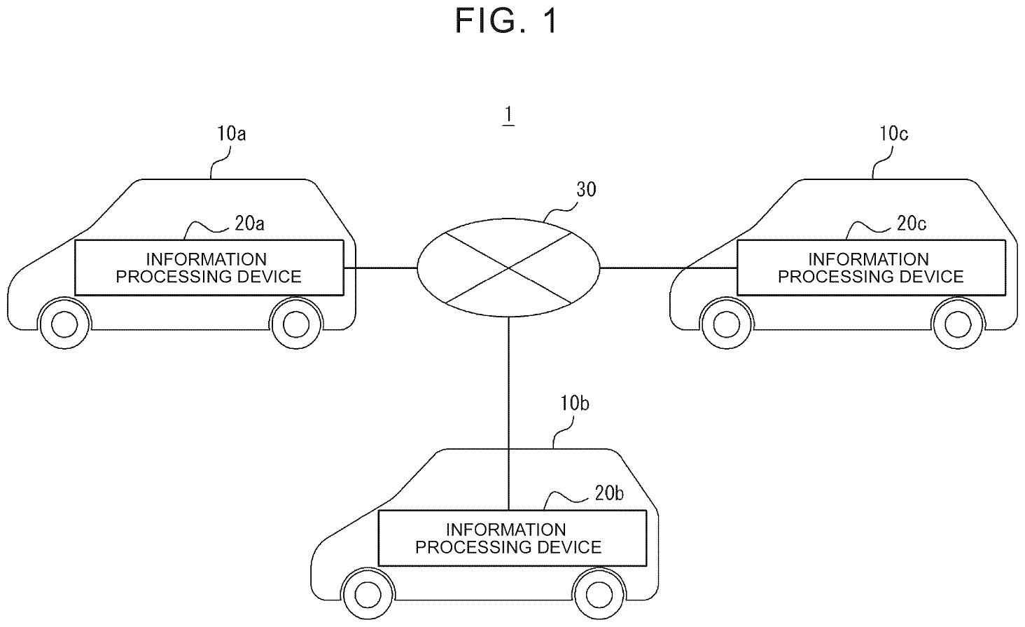

The outline of a system 1 according to an embodiment of the present disclosure will be described with reference to FIG. 1. Hereinafter, in the present embodiment, a case where the moving object is a vehicle will be described. The system 1 includes a vehicle 10a, a vehicle 10b, a vehicle 10c, an information processing device 20a, an information processing device 20b, and an information processing device 20c. The information processing device 20a, the information processing device 20b, and the information processing device 20c are communicably connected to a network 30 including, for example, the Internet and a moving object communication network. In the present specification, when the vehicle 10a, the vehicle 10b, and the vehicle 10c are not distinguished from each other, they are collectively referred to as a vehicle 10. In addition, in the present specification, when the information processing device 20a, the information processing device 20b, and the information processing device 20c are not distinguished from each other, they are collectively referred to as an information processing device 20.

The vehicle 10 is, for example, an automobile, a bicycle, or the like, but is not limited thereto, and may be any vehicle. Motor vehicles include, but are not limited to, for example, gasoline-powered vehicles, battery electric vehicle (EV), hybrid electric vehicle (HV), plug-in hybrid electric vehicle (PHV), or fuel cell electric vehicle (FCV).

The information processing device 20 is any device used by an occupant of the vehicle 10. For example, a dedicated in-vehicle device can be employed as the information processing device 20. The information processing device 20 may be a general-purpose electronic device such as a smartphone or a tablet terminal.

Although FIG. 1 illustrates an example in which the system 1 includes three vehicles 10 and three information processing devices 20, the present disclosure is not limited thereto. The system 1 may include four or more vehicles 10 and four or more information processing devices 20.

### Configuration of Information Processing Device

Next, each configuration of the information processing device 20 will be described in detail.

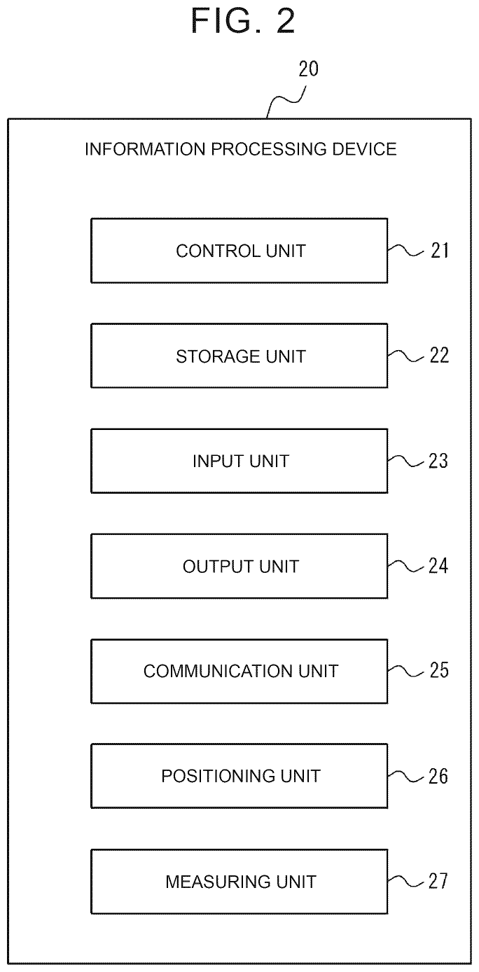

As illustrated in FIG. 2, the information processing device 20 includes a control unit 21, a storage unit 22, an input unit 23, an output unit 24, a communication unit 25, a positioning unit 26, and a measurement unit 27.

The control unit 21 includes at least one processor, at least one dedicated circuit, or a combination thereof. A processor is a general-purpose processor such as central processing unit (CPU) or graphics processing unit (GPU), or a special-purpose processor specialized for a particular process. The dedicated circuitry is, for example, field-programmable gate array (FPGA) or application specific integrated circuit (ASIC). The control unit 21 executes processes related to the operation of the information processing device 20 while controlling various units of the information processing device 20.

The storage unit 22 includes at least one semiconductor memory, at least one magnetic memory, at least one optical memory, or a combination of at least two of them. Semiconductor memories are, for example, random access memory (RAM) or read only memory (ROM). RAM is, for example, static random access memory (SRAM) or dynamic random access memory (DRAM). ROM is, for example, electrically erasable programmable read only memory (EEPROM). The storage unit 22 functions as, for example, a main storage device, an auxiliary storage device, or a cache memory. The storage unit 22 stores data used for the operations of the information processing device 20 and data obtained through the operations of the information processing device 20.

The input unit 23 includes at least one input interface. The input interface is, for example, a touch screen integrally provided with a physical key, a capacitive key, a pointing device, and a display. The input interface may be, for example, a sound sensor that receives an audio input, a camera that receives a gesture input, or the like. The input unit 23 receives an operation of inputting data used for the operation of the information processing device 20. Instead of being provided in the information processing device 20, the input unit 23 may be connected to the information processing device 20 as an external input device. As the connecting method, any method such as Universal Serial Bus (USB), High-Definition Multimedia Interface (registered trademark) (HDMI), or Bluetooth (registered trademark) can be used, for example.

The output unit 24 includes at least one output interface. The output interface is, for example, a display or the like that outputs information by video. The display is, for example, a liquid crystal display (LCD) or an organic electro luminescence display. The output unit 24 displays and outputs data obtained by the operation of the information processing device 20. The output unit 24 may be connected to the information processing device 20 as an external output device instead of being provided in the information processing device 20. As a connection method, for example, any method such as USB, HDMI (registered trademark), or Bluetooth (registered trademark) can be used.

The communication unit 25 includes a communication interface connected to a network. When the information processing device 20 is mounted on a vehicle, the communication unit 25 may also include a communication interface connected to CAN. The communication interface connected to the network corresponds to, for example, a vehicle-to-vehicle communication standard (for example, V2X) or a moving object communication standard, but is not limited thereto, and may correspond to any communication standard. In the present embodiment, the information processing device 20 included in a certain moving object is wirelessly connected to the information processing device included in another moving object via the communication unit 25 and the network 30. The communication unit 25 receives data used for the operation of the information processing device 20, and sends data obtained by the operation of the information processing device 20.

The positioning unit 26 includes one or more devices that acquire location information of the information processing device 20 (that is, location information of the vehicle 10). Specifically, the positioning unit 26 includes, for example, a receiver corresponding to GPS, but is not limited thereto, and may include a receiver corresponding to any satellite-based positioning system.

The measurement unit 27 includes one or more sensors. The measurement unit 27 may include a gyro sensor, an acceleration sensor, a geomagnetic sensor, an atmospheric pressure sensor, and the like. However, the sensor is not limited thereto.

The function of the information processing device 20 is realized by executing the program according to the present embodiment by a processor corresponding to the information processing device 20. That is, the functions of the information processing device 20 are realized by software. The program causes the computer to execute the operation of the information processing device 20, thereby causing the computer to function as the information processing device 20. That is, the computer functions as the information processing device 20 by executing the operation of the information processing device 20 in accordance with the program.

In the present embodiment, the program can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a digital versatile disc (DVD) or a compact disc read only memory (CD-ROM) in which the program is recorded. Further, the program may be distributed by storing the program in the storage of the external server and sending the program from the external server to another computer. Further, the program may be provided as a program product.

Part or all of the functions of the information processing device 20 may be realized by a dedicated circuit corresponding to the control unit 21. That is, some or all of the functions of the information processing device 20 may be realized by hardware.

### Operation of the Information Processing Device

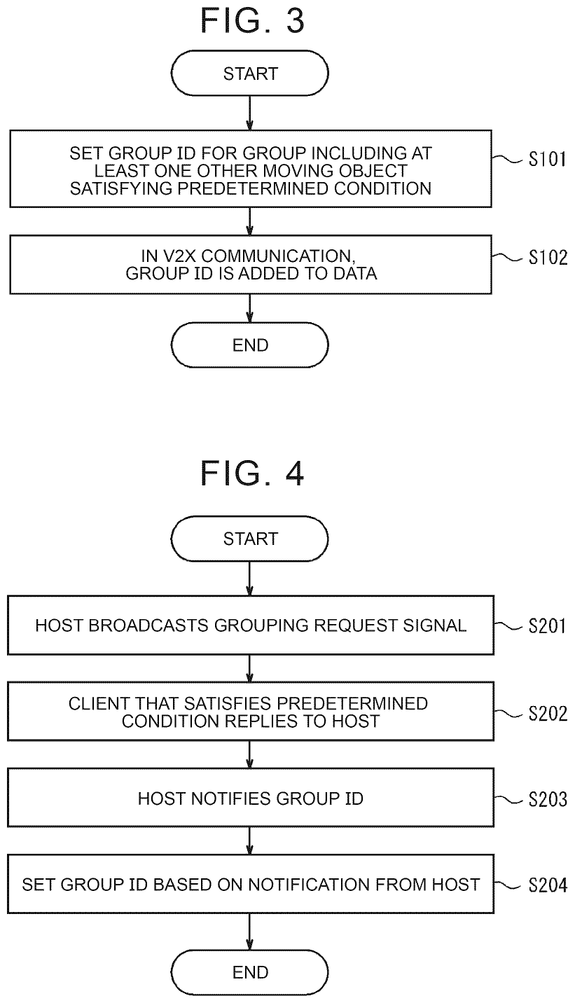

Referring to the flowchart of FIG. 3, an operation of an information processing device according to an embodiment of the present disclosure is illustrated.

S101: The control unit 21 of the information processing device 20 sets a group ID related to a group including at least one other moving object that satisfies a predetermined condition. The group ID is identification-information for uniquely identifying a group used in data communication of a group including a plurality of moving objects. That is, the control unit 21 performs grouping of a plurality of moving objects. As the method of grouping, any method can be adopted as described later.

S102: The control unit 21 adds the group ID to the data in V2X communication. Then, the control unit 21 adds the group ID to perform data communication. By adding the group ID to the data of V2X communication, the devices that perform the data communication can utilize the group ID. For example, the destination of the data-transmission can be specified by a group ID. In addition, it is easy to determine whether or not the data is the data whose destination is self by the group ID. In this way, V2X communication technique is improved in that a group including a plurality of moving objects can utilize a common group ID in V2X communication.

### How to Configure Group ID

The above-described method of setting the group ID can be adopted in any manner. Referring to the flow chart of FIG. 4, an exemplary method of setting a group ID is shown. Hereinafter, an exemplary operation of setting a group ID based on host client communication between an information processing device (hereinafter, also referred to as a host) of a moving object that determines a group ID and an information processing device (hereinafter, also referred to as a client) of another moving object that belongs to the group will be described. Here, it is assumed that the host is an information processing device 20a mounted on the vehicle 10a, and the client is an information processing device 20b mounted on the vehicle 10b. Hereinafter, a configuration of the information processing device 20a is referred to as a control unit 21a, a storage unit 22a, an input unit 23a, an output unit 24a, a communication unit 25a, a positioning unit 26a, and a measurement unit 27a. A configuration of the information processing device 20b is defined as a control unit 21b, a storage unit 22b, an input unit 23b, an output unit 24b, a communication unit 25b, a positioning unit 26b, and a measurement unit 27b.

S201: The control unit 21a of the host-side information processing device 20a broadcasts the grouping request signal through ITS direct communication. The grouping request signal is a signal including, in the service ID, an ID representing the grouping request. The grouping request signal includes a predetermined condition. For example, the predetermined condition may be that the location of the moving object of the client is within a predetermined radius (hereinafter, also referred to as a group radius) from the moving object of the host. In other words, the predetermined condition may include that its location is within a group radius from the host moving object. In this case, the grouping request signal includes the location information of the host and the information of the group radius. The location information is acquired by the positioning unit 26a.

The grouping request signal may include a type of a group (hereinafter, also referred to as a group type). The group type is information indicating the type of the moving object. For example, the group type is an automobile, a bicycle, a pedestrian, or the like. When the grouping request signal includes the group type, the predetermined condition may include that the group type of the grouping request signal matches the group type included in the grouping request signal. The group type may be stored in the storage unit 22 of each information processing device 20. Hereinafter, in the present embodiment, it is assumed that the predetermined condition is that its location is within the group radius from the host moving object, and that its group type matches the group type included in the grouping request signal. It should be noted that the grouping request signal may be periodically sent, for example, in a fixed cycle. As a result, the group is periodically reviewed. For example, the grouping request signal may be sent only before the specific service is activated. In addition, for example, the grouping request signal may change the transmission period according to a reply state of an acknowledge signal described later.

S202: The control unit 21b of the information processing device 20b performs a determination related to its own group type and a determination related to its own location based on the group type and the group radius. If it is determined that the target is a grouping target (a target for setting the group ID), the control unit 21b returns an acknowledge signal to the host. In other words, the client that satisfies the predetermined condition returns an acknowledge signal to the host. The control unit 21b acquires its own location from the positioning unit 26b and performs the above-described determination process. The acknowledgement signal includes a moving object ID of the client. The moving object ID is identification information that uniquely identifies a moving object, and is stored in the storage unit 22.

S203: When an acknowledge signal is received from the client, the control unit 21a of the information processing device 20a, which is the host, notifies the group ID to the moving object ID of the client. ID of groups notified by the host may be determined in any manner. For example, the host may store a default group ID in the storage unit 22a. The host may then notify the client of the default group ID.

S204: Upon receiving the group ID from the host, the control unit 21b of the information processing device 20b that is the client sets the group ID as the group ID of the group to which the client belongs. In other words, the client configures the group ID based on the notification from the host. Specifically, the control unit 21b stores the group ID in the storage unit 12b. In addition, when performing ITS communication thereafter, the control unit 21b adds a group ID in addition to its own moving object ID to perform data communication.

From the above-described S201, the group ID of the host and the client is set by S204, and is used in the subsequent data communication of V2X communication. Here, the host-client relationship after the group is formed may or may not be maintained. For example, in the case of maintaining a host-client relationship, the hosts of the group may manage the number, type, location, and the like of the moving objects being grouped. The hosts of the group may also send a grouping request service to confirm that the group is maintained after the group is formed. The client side may also confirm whether or not the client side belongs to the group by receiving the grouping request signal for confirmation.

On the other hand, for example, when the host-client relationship is not maintained, the information processing device of any moving object in the group can send the grouping request signal. When the group ID is the same as the group to be grouped at the time of reception, the information processing device of the moving object replies. In other words, in this case, it is possible to keep checking with each other whether the hosts are to be grouped while being replaced. In addition, the grouping request signal sent by any information processing device in the group can be sent by an information processing device outside the group and propagated through the group.

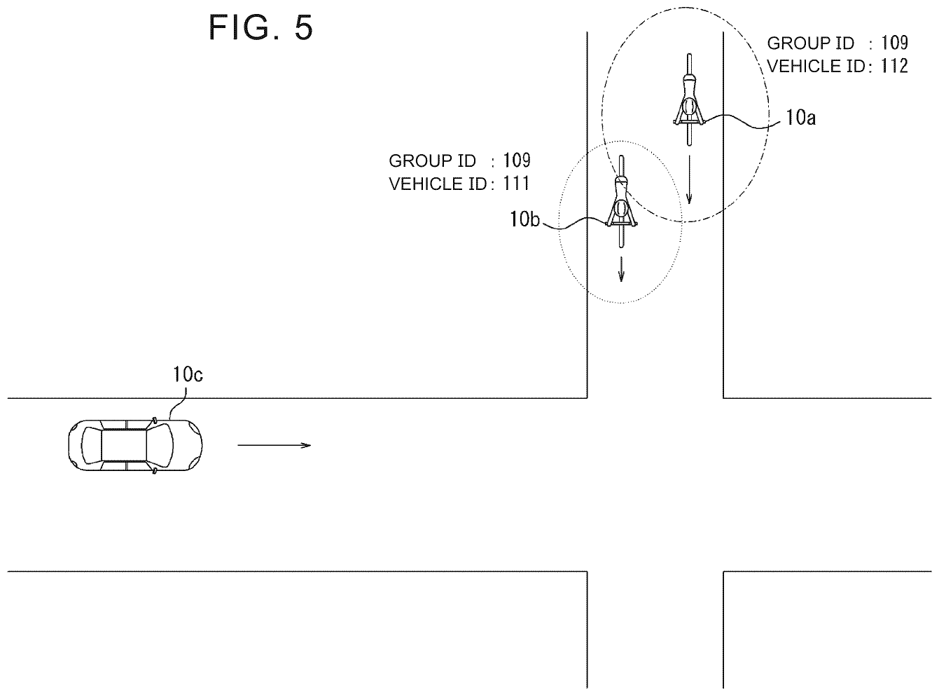

FIG. 5 shows an example of grouping. In this embodiment, the vehicle 10a and the vehicle 10b are both bicycles, and the vehicle 10c is an automobile. In addition, an information processing device 20a, an information processing device 20b, and an information processing device 20c are mounted on the vehicle 10a, the vehicle 10b, and the vehicle 10c. Each of the information processing device 20a and the information processing device 20b is a bicycle. The area 100a indicates an area within the grouping radius when the information processing device 20a is hosted. The area 100b indicates an area within the grouping radius when the information processing device 20b is hosted. As illustrated in FIG. 5, the information processing device 20b exists in an area within the grouping radius when the information processing device 20a is hosted. Therefore, when the grouping request signal is sent from the information processing device 20a, the information processing device 20b returns an acknowledge signal. As a result, a shared group ID is set in the information processing device 20a and the information processing device 20b. Specifically, in FIG. 5, “109” is set as the group ID in the information processing device 20a and the information processing device 20b. In addition, the vehicle identification (ID) 10a, 10b is set for the vehicle 10a and the vehicle 10b, respectively. The information processing device 20a and the information processing device 20b add the group ID to the data when sending the data in V2X communication. Thus, the receiver of V2X communication can grasp the group ID related to the information processing device 20a and the information processing device 20b.

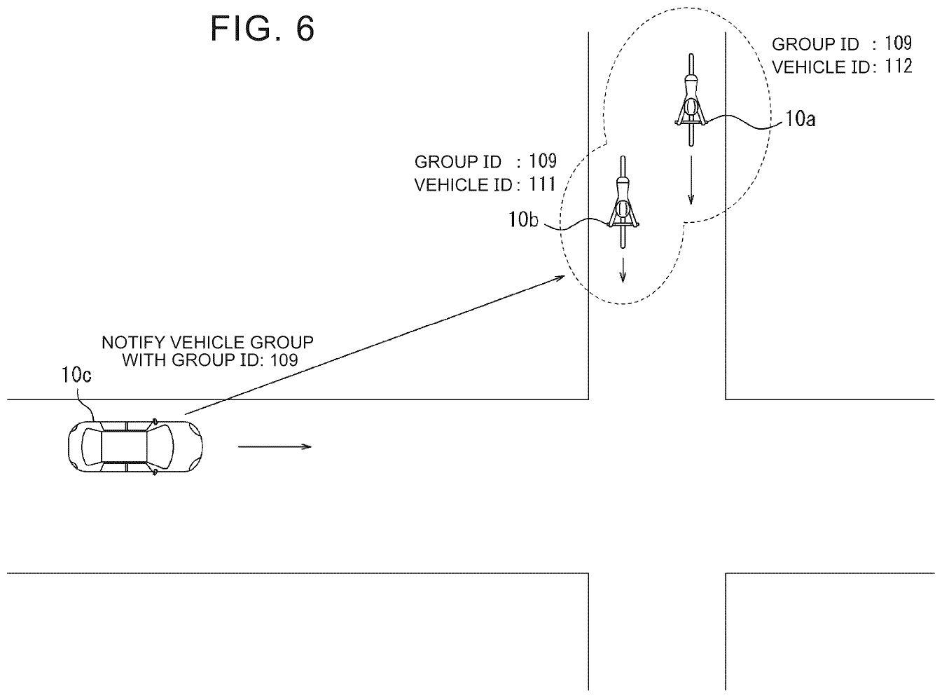

FIG. 6 is a conceptual diagram of communication when a group ID is set. As described above, since the information processing device 20a and the information processing device 20b add the group ID to the data in V2X communication, the information processing device 20c of the vehicle 10c can grasp the group ID of the information processing device 20a and the information processing device 20b. Therefore, the information processing device 20c can send data destined for the group ID. In FIG. 6, the information processing device 20c mounted on the vehicle 10c notifies the group of vehicles with the group ID 109. For example, when a notification condition to at least one of the information processing device 20a and the information processing device 20b is satisfied in an operation related to at least one of the information processing device 20a and the information processing device 20b, the information processing device 20c adds a group ID to send data. Thus, both the information processing device 20a and the information processing device 20b can be notified. Specifically, for example, when the speed of the vehicle 10a on which the information processing device 20a is mounted is equal to or higher than the predetermined speed and the notification condition of the attention calling information is satisfied, the information processing device 20b mounted on the vehicle 10b existing in front of the intersection can also be notified of the attention calling information, and the information processing device 20b can also receive the warning signal.

As described above, the information processing device 20 according to the present embodiment adds the group ID to the data in V2X communication. By adding the group ID to the data of V2X communication, the devices that perform the data communication can utilize the group ID. For example, the destination of the data-transmission can be specified by a group ID. In addition, it is easy to determine whether or not the data is the data whose destination is self by the group ID. In this way, V2X communication technique is improved in that a group including a plurality of moving objects can utilize a common group ID in V2X communication.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 20 may be distributed among a plurality of computers capable of communicating with each other. Further, for example, an embodiment in which some or all of the components of the information processing device 20 are provided in the vehicle 10 is also possible. For example, the navigation device mounted on the vehicle 10 may include some or all of the components of the information processing device 20.

As a method of determining the group radius, any method can be adopted. For example, a unique group radius may be determined according to a group type. For example, when the group type is a car, a bicycle, or a pedestrian, the group radii for these group types may be different radii r1, r2, and r3, respectively. These magnitude relations may be, for example, r1>r2>r3. In addition, the group radius may dynamically change according to the moving state such as the speed, acceleration, and the like of the moving object. In this case, the lower limit value of the group radius may be determined.

Further, in the present embodiment, an example has been shown in which the predetermined condition in the grouping is that its location is within the group radius from the moving object, but the present disclosure is not limited thereto. For example, the predetermined condition may include that its direction of travel is substantially the same as the direction of travel of the moving object. In this case, the control unit 21 of the information processing device 20 may grasp its own direction of travel based on the measurement result of the measurement unit 27. As a result, it is possible to group the moving objects having substantially the same direction of travel, and it is possible to perform broadcast communication with the information processing device included in the moving object.

Further, for example, the predetermined condition may be located within a predetermined distance range from the traffic infrastructure equipment. The traffic infrastructure equipment includes traffic lights and the like at intersections. When grouping is performed based on the traffic infrastructure equipment, the information processing device 20 may be mounted on the traffic infrastructure equipment, and the information processing device 20 may be hosted to set the group ID. In this case, the predetermined condition of the grouping request signal sent by the information processing device 20 may be that the location of the client is within a predetermined radius (hereinafter, also referred to as a group radius) from the host. In other words, the predetermined condition may include that its location is within a group radius from the traffic infrastructure equipment. As a result, it is possible to group the moving objects within a predetermined distance from the traffic signal or the like at the intersection, and it is possible to make a simultaneous notification or the like to the information processing device 20 included in the moving object around the traffic infrastructure equipment.

The use of the group ID is not limited to the above. For example, the group ID is also useful in data communication such as communication within a group. For example, in addition to sharing the location information of the members of the group, the destination, the information of the stop point, and the like can be easily shared by communication using the group ID. In this case, some data may be set so as not to be shared within the group. For example, it may be possible to make settings such as rejecting sharing of personal data (location information or the like) by setting of each member.

In addition, the movement policy may be shared within the group by communication within the group described above. The policy of movement may include, for example, heading to a destination in a hurry, slowly heading to a destination, etc.

In addition, by communicating within the above-described group, it may be possible to request the change of the hosts related to the setting of the group ID. For example, in a case where communication is performed to maintain the relationship between host clients, the host may be configured to be changed while the group is maintained.

Emergency action detection, such as an emergency brake/emergency handle, of a member of the group may also be shared by communication within the group described above. When a moving object belonging to a group takes an emergency action, the possibility of avoiding danger can be improved by sending the information to another moving object in the group.

What is claimed is:

1. An information processing method in vehicle-to-everything communication that is performed by an information processing device of a moving object, the information processing method comprising:
setting a group identification for a group including at least one other moving object that satisfies a predetermined condition; and
adding the group identification to perform data communication in the vehicle-to-everything communication.

2. The information processing method according to claim 1, wherein setting the group identification includes
sending a grouping request signal by broadcast,
receiving an acknowledge signal from an information processing device of the at least one other moving object that satisfies the predetermined condition, and
setting the group identification for the information processing device of the at least one other moving object that satisfies the predetermined condition.

3. The information processing method according to claim 1, wherein the predetermined condition includes that a location of the at least one other moving object is within a group radius from the moving object.

4. The information processing method according to claim 1, wherein the predetermined condition includes that a direction of travel of the at least one other moving object is substantially the same as a direction of travel of the moving object.

5. The information processing method according to claim 1, wherein the predetermined condition includes that the at least one other moving object is located within a predetermined distance range from traffic infrastructure equipment.
